(19) United States
(12) Patent Application Publication
(10) Pub. No.: US 2016/0189166 A1
(43) Pub. Date: Jun. 30, 2016

(54) Establishing and Managing Online Presence of a Business

(71) Applicant: UBL Interactive, Inc., Charlotte, NC (US)

(72) Inventors: Doyal BRYANT, Charlotte, NC (US); Chris TRAVERS, New York, NY (US); Damian ROLLISON, Pismo Beach, CA (US)

(21) Appl. No.: 14/588,113

(22) Filed: Dec. 31, 2014

(51) Int. Cl. G06Q 30/00

(52) U.S. Cl. CPC G06Q 30/018

(57) ABSTRACT

Certain embodiments of these teachings include collecting business profile information from a plurality of end user business entities, and associating each of the end user business entities with at least some online directory listing verifiers. An electronic address for each of the end user business entities is created and portions of the respective collected business profile information are optimized with respect to the associated online directory listing verifiers. In parallel, some of the respective business profile information is electronically submitted to a business profile for the respective end user business entity at each of the associated online directory listing verifiers. For each of the end user business entities, a report is outputted which lists for each associated online directory listing verifier whether the business profile has been verified or actions that are needed to complete verification.

### TECHNICAL FIELD

The invention relates generally to online business profiles. Specifically, embodiments of the present invention relate to methods for establishing and/or updating verified online business profile listings.

### BACKGROUND

With the always increasing number of mapping services, local business directories, social websites and the like, businesses have a difficult time updating and tracking their online information. Online information pertaining to a business is often missing, lacking, inaccurate or contradictory on different websites and applications, which may negatively impact the business's ability to attract customers and therefore sales. Business owners are generally occupied with the day to day operations of their business and typically do not have the time, resources and specialized knowledge to update this information. Furthermore, businesses often have insufficient experience to understand and capitalize on the value of creating and maintaining accurate online profiles across these websites and services.

There is a need for a method to efficiently establish and manage the online presence of a business across multiple websites and services. One aspect of this is the establishment and maintenance of online business profiles that are verified and hosted by third party web entities such as for example Google®, Yahoo®, and other such aggregators of business profiles that are used when consumers search for a business online.

### SUMMARY

Embodiments of the present invention are directed to a method that satisfies the need for managing and verifying the online presence of a business entity.

In a first exemplary embodiment, the method comprises collecting business profile information from each of a plurality of end user business entities, at least some of the end user business entities being independent of any other of the plurality; associating each of the end user business entities with one or more online directory listing verifiers; establishing an electronic address for each of the end user business entities; for each of the end user business entities and each of respectively associated online directory listing verifiers, selecting portions of the respective collected business profile information for optimization with respect to said respectively associated online directory listing verifier; in parallel for each of the end user business entities, electronically submitting at least some of the respective business profile information to a business profile for the respective end user business entity at each of the associated online directory listing verifiers; and for each of the end user business entities, outputting a report listing for each associated online directory listing verifier whether the business profile has been verified or actions that are needed to complete verification.

In a second exemplary embodiment of the invention, there is a non-transitory computer readable memory storing a computer program that is executable by at least one processor, in which the computer program comprises: code for collecting business profile information from each of a plurality of end user business entities, at least some of the end user business entities being independent of any other of the plurality; code for associating each of the end user business entities with one or more online directory listing verifiers; code for establishing an electronic address for each of the end user business entities; in parallel for each of the end user business entities, code for electronically submitting at least some of the respective business profile information to a business profile for the respective end user business entity at each of the associated online directory listing verifiers, including for electronically submitting to respective ones of the associated online directory listing verifiers selected portions of the respective collected business profile information that are optimized with respect to said respectively associated online directory listing verifier; and for each of the end user business entities, code for outputting a report listing for each associated online directory listing verifier whether the business profile has been verified or actions that are needed to complete verification.

In a third exemplary embodiment, there is an apparatus comprising at least one processor and at least one memory storing a computer program, in which the at least one memory with the computer program is configured with the at least on processor to cause the apparatus to at least: collect business profile information from each of a plurality of end user business entities, at least some of the end user business entities being independent of any other of the plurality; associate each of the end user business entities with one or more online directory listing verifiers; establish an electronic address for each of the end user business entities; in parallel for each of the end user business entities, electronically submit at least some of the respective business profile information to a business profile for the respective end user business entity at each of the associated online directory listing verifiers, including for electronically submitting to respective ones of the associated online directory listing verifiers selected portions of the respective collected business profile information that are optimized with respect to said respectively associated online directory listing verifier; and for each of the end user business entities, output a report listing for each associated online directory listing verifier whether the business profile has been verified or actions that are needed to complete verification.

### BRIEF DESCRIPTION OF THE DRAWINGS

These and other features, aspects, and advantages of the present invention will become better understood with regard to the following description, appended claims, and accompanying drawings, where:

FIG. 1 is a process flow diagram according to certain exemplary embodiments of these teachings.

FIG. 2 is an example of a report according to certain exemplary embodiments of these teachings.

FIG. 3 is a high level schematic block diagram illustrating a computing device that is suitable for practicing the described and exemplary embodiments of these teachings.

### DETAILED DESCRIPTION

In the Summary above and in the Detailed Description and the claims below, and in the accompanying drawings, reference is made to particular features (including method steps) of the invention. It is to be understood that these various features may be combined despite that the description herein does not explore explicitly every single such possible combination. The specific embodiments that are detailed below with particularity are not a limit to the general teachings herein, and such exemplary embodiments by themselves are not a limit to the scope of the ensuing claims but rather teach the principles of the invention and illuminate the meaning of such ensuing claims.

The term “comprises” and grammatical equivalents thereof are used herein to mean that other components, steps, etc. are optionally present. For example, an article “comprising” (or “which comprises”) components or steps A, B, and C can consist of (i.e., contain only) components or steps A, B and C, or in another embodiment may include not only components or steps A, B and C but also one or more additional components or steps.

When reference is made herein to a method comprising two or more defined steps, the defined steps can be carried out in any order or simultaneously (except where the context excludes that possibility), and the method may further include one or more additional steps which are carried out before any of the defined steps, between two of the defined steps, or after all the defined steps (except where the context excludes that possibility).

As stated in the background above, businesses have an interest in creating an online presence and assessing their market efforts online across multiple websites and services. Many websites and services allow businesses to create online profiles as a way to interact with their customers. Typically, a business profile can obtain a “verified” or “claimed” status from online directory listing entities to indicate to customers that the information on the profile is provided directly by the business. When a business fails to claim or verify the profile, the information in the profile may be populated using information from other sources. Normally such profile information is populated using information provided by telephone companies or through the use of “crowdsourcing”. Crowdsourcing occurs when users of a website or service are allowed to create an online profile and provide information on behalf of a business. The resulting profile is considered unverified, but the information in many cases can still be visible to other users. Information in unverified profiles may be incomplete or inaccurate.

Many of these websites and services that make online directory listings visible to the general public will apply filters so that users are provided with the most relevant profiles. For example, when a user searches a mobile mapping application for “sandwiches” at lunch time then the application's search of one or more online directory listing databases may provide the user with restaurants that are currently open and serve sandwiches. If a restaurant profile contains erroneous information regarding the type of food the restaurant serves or the hours of operation then the restaurant's online profile may not be returned in the search results and not be displayed to the user. In certain cases an erroneous, inaccurate or non-optimized online profile listing can significantly impact the sales of such a restaurant.

The term “online directory listing verifiers” is used throughout the written description to encompass all websites and services that allow a business entity to claim a profile, including third party verifiers acting as agents for the actual listing service/entity to perform the verification steps that the directory listing service/entity requires. As used herein, online directory listing verifier refers to the entity performing verification of profile information of end user business entities for listing by an online directory listing entity, and so includes the entity itself as well as third party agents of such an entity. Online directory listing verifiers include, for example, Internet Yellow Pages (IYP), social networks, mobile applications, directory sites, and the like. Although online directory listing verifiers may use different terminology to describe owner verified profiles, the term “verified profile” is used hereinafter to describe all such profiles and includes, for example, claimed profiles, authenticated profiles, validated profiles, real profiles, and the like.

In a similar vein, business entities as used herein also encompasses certain public figures whose profession is inexorably tied to their persona; for example a musician that establishes an online profile listing venues, dates and times of the musician's current or next upcoming tour, or a motivational speaker, sports figure or campaigning politician whose online profile reflects similar such current and upcoming personal appearances.

A business entity must perform some action to take control of a profile on a directory listing verifier to obtain a verified profile which provides the business entity with full control of the information on the business profile once it is verified. By verifying the profile, the business entity prevents unauthorized users from changing the business information. For business entities, verified profiles are the best way to ensure that customers can efficiently and accurately find their business online. However, the process for establishing claimed profiles is complex, laborious, and prone to error. Many online directory listing entities require an end user business entity to complete a verification process to ensure that the business information, and the individual setting up the profile, is legitimate. Not only do directory listing entities/verifiers frequently update and change the verification process, but each verification process may be different for different directory listing entities/verifiers. The end user business entity must repeat this process for each different directory listing verifier with whom the end user business entity desires to have a verified profile. The number of directory listing verifiers is constantly growing which additionally requires the end user business entities to repeatedly create new profiles and manage their existing profiles in order to provide the most accurate information to the greatest number of customers and potential customers.

An online directory listing verifier will typically provide a business entity with one or more options to verify a business profile. For example, the following processes are typically used by online directory listing verifiers:
The business entity requests that the directory listing verifier make an automated phone call to the business entity's phone number. During the telephone call the directory listing verifier provides the end user business entity with a personal identification number (PIN). The end user business entity completes the verification process by entering the PIN at a specific website.
The end user business entity will initiate a letter or postcard to be sent from the online directory listing verifier to the address of the business entity. The postcard or letter provides a PIN that is associated with the business entity and end user business entity needs to enter the PIN at a specific website to verify the business profile to complete the verification process.
The end user business entity provides a business domain server owned by the business entity during the profile creation process. The online directory listing verifier sends an e-mail to an e-mail address associated with the business domain. The recipient of the e-mail may verify the business profile by replying to the e-mail or clicking a link contained in the e-mail.
The end user business entity requests the online directory listing verifier to send a verification e-mail which contains a PIN. The e-mail need not match the domain of the business website. Like the previous verification process, the recipient of the e-mail may verify the business profile by replying to the e-mail or clicking a link contained in the e-mail.
   Some online directory listing verifiers offer all or some of the above mentioned verification processes as options to verify a business profile, while others offer one of the verification processes.

Certain embodiments of the invention provide an integrated solution for organizing the multiple-stage process of business profile creation, assisting with repetitive form filling tasks, optimizing the business profile information for a respective online directory listing verifier and coordinating the actions of operators and the end user business entity. Performing these actions for a plurality of business entities in parallel greatly reduces the time and expense of verified profile creation and increases the quality and accuracy of business profiles when dealing with the various and dynamic publication requirements of multiple directory listing verifiers.

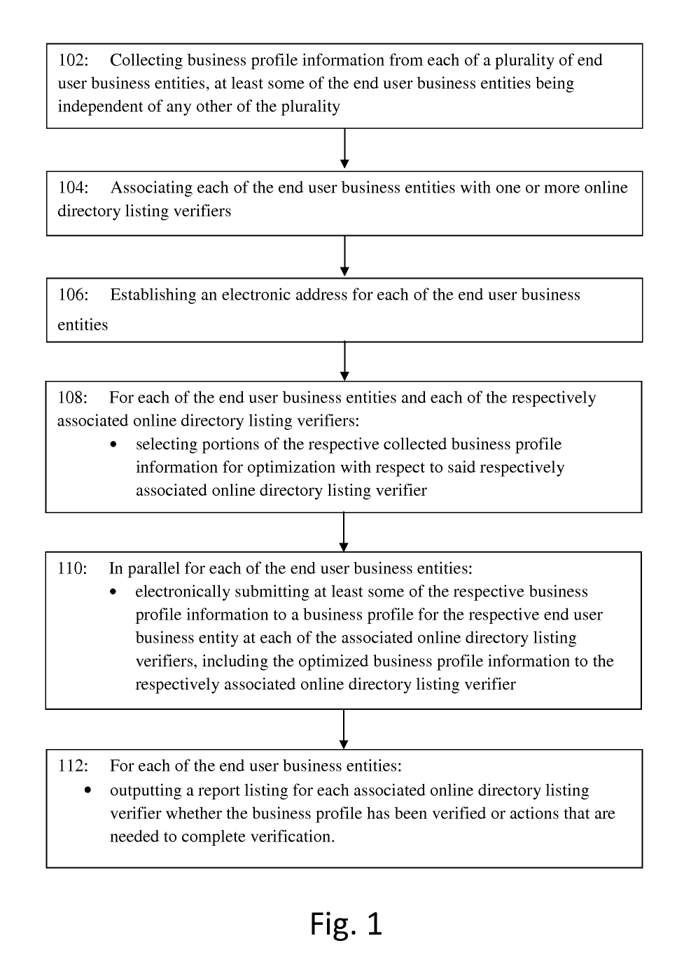

FIG. 1 shows a process flow diagram according to exemplary embodiments of these teachings. FIG. 1 establishes an efficient, repeatable, automated procedure for the submission of business profile information and the successful, timely completion of the business entity verification process. At step 102, business profile information is collected from each of a plurality of end user business entities. At least some of the end user business entities being independent of any other of the plurality. The information of each of the end user business entities may be collected from the business owner, an employee, an agent or a representative who is otherwise authorized to complete the verification processes for a given online directory listing verifier. The business profile information may include, for example, the business name, address, phone number, business category, web address, products, brands, hours of operation, and any other elements needed to complete a business profile.

At step 104, each of the end user business entities is associated with one or more online directory listing verifiers. For example, an end user business entity may provide a specific list of online directory listing verifiers where business profiles are to be created. Alternatively, if no list is provided, a default set of online directory listing verifiers may be associated with an end user business entity. At step 106, an electronic address is established for each of the end user business entities. According to one embodiment, the electronic address is an e-mail address.

At step 108, for each of the end user business entities and each of the respectively associated online directory listing verifier portions of the collected information are selected for optimization. The optimization process includes, for example, ensuring all basic information about a business entity is accurately represented in the business profile. The basic information includes, for example, the business name, address, and phone number. The optimization process may further include adding information, such as hours of operation, payment methods, logos, photos, videos, lists of products sold or services provided, lists of brands carried, special certifications, and the like. Optimization serves at least two purposes. First, verified profiles may be obtained more efficiently by ensuring any requirements and guidelines of a respective online directory listing verifier have been met. Second, after a business profile is verified, the optimized information allows the profile to stand out among competing businesses, causing it to rank higher or otherwise become more likely to gain attention from consumers searching for businesses on the site.

At step 110, at least some of the collected information is submitted electronically to a business profile for the respective end user business entity at each of the associated online directory listing verifiers. In a certain embodiment of the invention, submitting the collected information to the business profile is accomplished by filling out any necessary fields or forms on an online directory listing verifier automatically. Step 110 is carried out in parallel for each of the plurality of end user business entities from step 102. In the context of the invention, in parallel means that the processing of multiple end user business entities is ongoing between some start and end time period and not necessarily that a given step is electronically performed for all the end user business entities at the same instant. Thus, for a given end user business entity this parallel processing means that all profiles for the associated directory listing verifiers are completed and verified at approximately the same time.

At step 112, a report is output for each for each of the end user business entities which lists, for each associated online directory listing verifier, either that the business profile has been verified or the specific actions that are needed to complete verification for a given directory listing verifier. The report may be output to be tangibly stored on a computer readable memory, or to a graphical display such as a computer screen or projector. The report also may be accessed by an end user business entity using a mobile application or website.

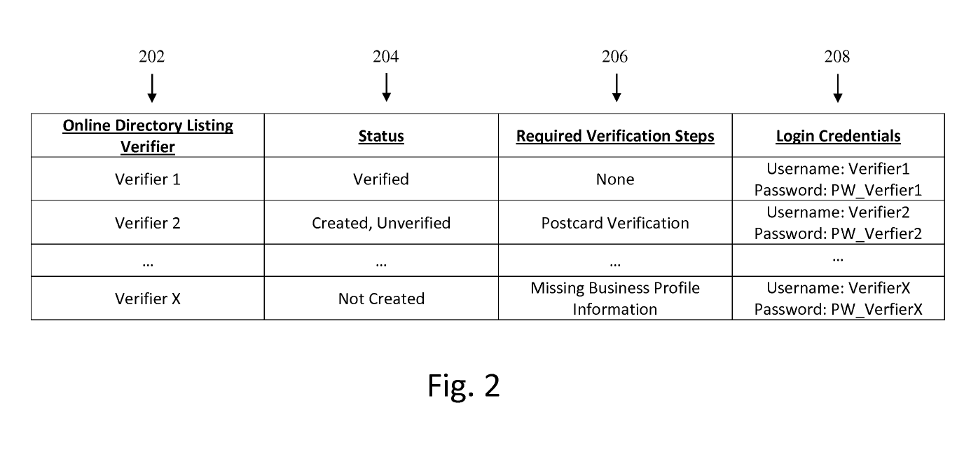

FIG. 2. illustrates an exemplary report output in step 112 for one of the end user business entities. The report may comprise, for example, a table as shown in FIG. 2. Column 202 lists the associated online directory listing verifiers that was established at step 104 of FIG. 1 for a given business entity. Column 204 shows the status for each of the online directory listing verifiers. The status column may indicate the current status of each of the online directory listing verifier profiles. For example, the status may be “verified”, “unverified”, “no existing profile” or other relevant statuses. Column 206 indicates specific actions that the end user business entity needs to perform in order to verify the business profile for a given associated online directory listing verifier. For instance, if a profile is not yet created column 206 may indicate what additional information is needed to create the profile. Column 206 indicates the required verification steps, which may be “none,” “postcard verification,” “phone verification,” “e-mail verification”, or some other status. Login credentials, for example usernames and passwords, for each business profile are outputted to the report, as shown in column 208. A username may be, for example, the same as the electronic address established in step 106, or the report may include multiple usernames and passwords which differ based on the requirements of the different directory.

During one or more steps, end user business entities may interact with one or more operators to assist the end user business in completing the method as illustrated by FIG. 1. In one embodiment, the outputted report from step 112 includes interactive components for scheduling an appointment with an operator or to complete required verification steps, for example, phone verification, postcard verification, or e-mail verification.

In another embodiment of the invention, the method determines whether a previously created business profiles exists on the one or more online directory listing verifiers for each of the end user business entities. If it is determined that a profile exists then it is further determined whether the existing profile is verified, accurate, and/or optimized. In such embodiments, the report in FIG. 2 may include a column indicating recommendations to the end user business entity on whether the existing profiles should be updated or optimized, which may be based at least partly on the business information collected in step 102. A given end user business entity may elect to update, optimize and verify at least one of the existing profiles concurrently with the other online directory listing verifiers in steps 108, 110 and 112. Optionally, the end user entity may provide any known login credentials for any existing profiles in step 102 of FIG. 1.

In another embodiment of the invention, the method may further comprise periodically sending a request to the plurality of business entities to collect updated business profile information. The request reminds the business entities after some predetermined time that the business profile information may be out of date. In response to the request, the end user business entity may send an acknowledgment that the business profile information is still accurate or send updated profile information.

In another embodiment of the invention after step 112, the method further comprises determining whether the information for each of the created verified profiles for a respective end user business entity is still optimized for the respective online business listing verifier. An online business listing verifier may provide updates to their business profiles, for example, additional fields may be added to business profiles that were not present when the verified profile was created. Alternatively, the business listing verifier may modify the calculation on how it ranks a business profile in search results. A business listing verifier may adjust its ranking calculation by ranking a profile higher in search results, for example, based on whether the profile contains pictures. When a directory listing verifier makes these types of adjustments to its ranking calculation, the verified profile for an end user business entity may be checked to ensure the profile remains optimized for the online directory listing verifier. If it is determined that a verified profile is not optimized, then the information in the profile can be re-optimized or a request may be sent to the end user business entity to provide additional business profile information to enable re-optimization of the profile.

In another embodiment, information is collected about an end user business entity which, for example, may be completed at step 102 of FIG. 1. The collected information is used to scan online sources for information potentially related to the business entity. Each online source is individually scored according to indicators including but not limited to depth of content, accuracy of content, freshness of content, consumer sentiment as determined by textual analysis, consumer ratings, frequency of occurrence, total number of occurrences, relative value of content, and consistency of similar content across multiple sources. All individual scores are combined to derive an overall score. The overall score is normalized to account for the differences between various websites and online information sources in order to produce a standard set of measurements. Optionally, the overall score can take into account standard indicators for the relative prominence of websites. The standard indicators may include but are not limited to Alexa, Comscore, Google Page Rank, and various standardized search engine optimization measurements.

The scanned online sources may include but are not limited to listings on business directory websites; profiles on social networking websites; user activity on social networking websites related to the business's online profile or containing content related to the business; public sources of information about the business such as federal, state, or local accreditation and licensure organizations; professional groups with which the business has an affiliation; online news websites; online blogs and user forums; online user activity related to the business location, such as check-ins; consumer reviews and ratings of the business; the business's own website or websites, including mobile versions of websites; presence of the business in mapping services; and evidence of advertising and marketing activity conducted by the business, including online pictorial and text advertisements. In a particular embodiment, the method determines whether the scanned information on the online sources accurately matches the information collected from, or provided by, the end user business entity. If the information from an online source is below a threshold value for matching then the online source is not included when calculating the overall score.

In one embodiment, an overall score is initially calculated for each of the plurality of end user business entities from step 102 of FIG. 1. This provides each of the end user business entities with a baseline score. The baseline score is output to the report in step 112. Changes to the overall score are captured over time and are output to the report and compared to previous scores in order to derive a historical trend for the business entity. In this way, the business entity can effectively measure, for example, the effects of creating and verifying online business profiles has on the business. The overall score allows a business to measure and track the effectiveness of the business's online presence, and allow the business to measure its marketing effectiveness relative to competitors and assess progress toward marketing goals, as well as providing consumers with a means of comparing businesses according to cues provided by multiple online users.

In another embodiment, a mobile application provides an end user business entity with a convenient means of managing its online presence from a mobile device, such as a smartphone or tablet. With the mobile application, the end user business entity can perform a number of actions related to the online presence of the business entity, including completion of verification steps for online profiles, modification of online content on multiple sites as managed from a single application interface, monitoring performance of online profiles over time and in comparison with competitor profiles, monitoring of consumer content such as reviews of the business on multiple sites, engagement with customers by means of social networking sites, and similar activities. The mobile application provides features and content that overlap with features provided by a website interface which is also provided to the end user, so that tasks can be easily started in one interface and completed in another, and so that the user has continual and consistent access to information and presence management features on multiple devices.

The mobile application also provides additional features, such as notifications that can be posted to the home screen of the user's device to alert the end user to important changes in online presence or to indicate the need for the end user to perform an action, such as completing a verification step or responding to an online review. In a scenario where a company is employing these teachings to help manage online presence for multiple business entities/clients in parallel, the mobile application can be downloaded to the client's device at the time the client signs up for service or at a later time, providing a means for establishing communication with the client and involving the client in the process of setting up and managing online profiles.

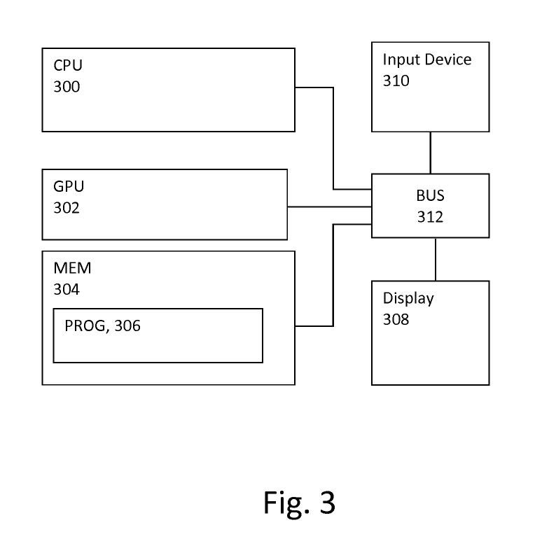

The logic diagram of FIG. 1 may be considered to illustrate the operation of a method, and a result of execution of a computer program stored in a computer readable memory, and a specific manner in which components of an electronic device are configured to cause that electronic device to operate. The various blocks shown in FIG. 3 may also be considered as a plurality of coupled logic circuit elements constructed to carry out the associated function(s), or specific result of strings of computer program code or instructions stored in a memory.

As shown in the high level block diagram of FIG. 3 a computing system is shown, which includes processing means such as at least one central processing unit (CPU) 300, a graphics processing unit (GPU) 302, storing means such as at least one computer-readable memory (MEM) 304 storing at least one computer program (PROG) 303, a display 308, and an input device 310, which are connected to communicate with one another through a BUS 312. Also stored in the MEM 304 at reference number 306 are the computer code or computer implementable algorithm(s) for the computer system to automatically fill in forms or fields for online directory listing verifiers, automate the production of status reports, and coordinating verification of a business profile with end user business entities. The computer program can be offered as a standalone package or may be integrated into other systems. For example, a reseller of online tools and services may wish to offer its customers certain aspects of the invention, in which case the computer program may be configured to integrate seamlessly with the reseller's other tools and services.

The MEM 304 may comprise a random access memory (RAM) and a mass storage. Various embodiments of the computer readable MEMs 304 include any data storage technology type which is suitable to the local technical environment, including but not limited to: semiconductor based memory devices, magnetic memory devices and systems, optical memory devices and systems, fixed memory, removable memory, disc memory, flash memory, volatile memory (e.g. DRAM, SRAM), non-volatile memory (e.g. EEPROM, NVRAM), and the like.

The CPU 300, the GPU 302, and the MEM 304 are shown as separate components, however in some embodiments, the MEM 304 may be integrated with one or both of the CPU 300 and the GPU 302, such as the case may be for a system on a chip (SoC). In some embodiments, the MEM 304 may be shared dynamically by the CPU 300 and the GPU 302. In some embodiments, MEM 304 is used by the CPU 300, and a second graphics RAM is dedicated for the use by the GPU 302. In some embodiments, the GPU 302 may be integrated with the CPU 300. In some embodiments, the computer system in FIG. 3 may lack a dedicated GPU 302, and the CPU 300 may be adapted to perform computations in place of the GPU 302. The CPU 300 and the GPU 302 may be operating in either 32-bit (single precision floating point) or 64-bit (double precision floating point) format.

The input device 310 may be a commonly known device for providing user input to a computer system, such as a mouse, a keyboard, a touch pad and/or a touch screen, or a transducer (e.g., a microphone) in conjunction with voice recognition software. The display 308 may be any commonly known graphical display screen or projector for displaying graphical images to a user. Although illustrated as separate blocks, the display 308 and the input device 310 may be integrated with one another, such as may be the case with a touch screen device. The display 308 may utilize any suitable display technology such as CRT, LED, OLED, Plasma, DLP and the like.

In some embodiments, the BUS 312 may include a northbridge for connecting the CPU 300, the GPU 302, and the MEM 304, and a southbridge for connecting the display 308 and the input device 310. In other embodiments, the northbridge may be integrated with the CPU 300.

In some embodiments, the input device 310 is adapted to provide commands to the CPU 300. In some embodiments the commands associate end user business entities with one or more online directory listing verifiers and establish electronic addresses of end user business entities. The commands may be entered through a user interface displayed on the display 308. In response to the some or all of these commands, the CPU 300 may be adapted to execute codes stored in the MEM 304. In some embodiments the computer system may be adapted to apply embodiments of the invention to in parallel electronically submit business profile information of an end user business entity to a business profile of online directory listing verifiers associated with the end user business entity. The computer system may also be adapted to output a report listing whether the business profile has been verified or actions that are needed to complete verification. The outputted report may be displayed on the display 308 and stored into the MEM 304.

In general, the various embodiments of the computer system in FIG. 3 can include, but are not limited to workstations, servers, personal desktop computers, laptop computers, tablets, personal portable digital devices having wireless communication capabilities, including but not limited to handheld or wearable computers such as cellular phones and smart phones, “Google Glass” devices, “Apple Watch” devices, implantable devices, and the like.

The embodiments of the present invention described herein provide a solution to the problem of efficiently establishing and managing the online presence of business entities across multiple websites and services. Embodiments of the present invention greatly reduce the time and effort in establishing and maintaining profiles for online directory listing verifiers than would be necessary if the profiles were created and managed separately.

Although the present invention has been described in considerable detail with reference to certain preferred versions thereof, other versions are possible. For example, although reference is made to verified profiles for businesses, verified online profiles for individuals can also benefit from the teachings herein. Therefore, the spirit and scope of the appended claims should not be limited to the description of the preferred versions contained herein.

What is claimed is:

1. A method comprising:
collecting business profile information from each of a plurality of end user business entities, at least some of the end user business entities being independent of any other of the plurality;
associating each of the end user business entities with one or more online directory listing verifiers;
establishing an electronic address for each of the end user business entities;
for each of the end user business entities and each of respectively associated online directory listing verifiers, selecting portions of the respective collected business profile information for optimization with respect to said respectively associated online directory listing verifier;
in parallel for each of the end user business entities, electronically submitting at least some of the respective business profile information to a business profile for the respective end user business entity at each of the associated online directory listing verifiers, including the optimized business profile information to the respectively associated online directory listing verifier; and
for each of the end user business entities, outputting a report listing for each associated online directory listing verifier whether the business profile has been verified or actions that are needed to complete verification.

2. The method according to claim 1, further comprising:
determining whether a previously created business profile exists on the one or more online directory listing verifiers for each of the end user business entities.

3. The method according to claim 2, wherein the previously created business profile for a given end user business entity is updated based at least on the collected business profile information.

4. The method according to claim 1, wherein for at least one of the end user business entities the outputted report includes at least one action that is needed to complete verification, the method further comprising:
scheduling an appointment for the at least one end user business entity to complete the at least one action needed to complete verification.

5. The method according to claim 1, wherein electronically submitting comprises using computer software to automatically fill out forms of the business profile for the respective end user business entity at each of the associated online directory listing verifiers.

6. The method according to claim 1, wherein the actions that are needed to complete verification include at least one of:
receiving a telephone call from one of the online directory listing verifiers;
inputting a personal identification number (PIN) from a postcard received by the respective end user business entity; and
responding to an e-mail sent to an e-mail address of the respective end user business entity.

7. The method according to claim 1, wherein the report further comprises a username and a password for each of the associated online directory listing verifiers.

8. The method according to claim 7, wherein the username is the established electronic address.

9. The method according to claim 1, further comprising:
after outputting the report, periodically sending a request to or on behalf of at least some of the plurality of business entities to collect updated business profile information.

10. The method according to claim 9, further comprising:
periodically checking the verified profiles for a respective end user business entity to determine whether the information for a given verified profile is currently optimized for the respective online business listing verifier.

11. A non-transitory computer readable memory storing a computer program that is executable by at least one processor, in which the computer program comprises:
code for collecting business profile information from each of a plurality of end user business entities, at least some of the end user business entities being independent of any other of the plurality;
code for associating each of the end user business entities with one or more online directory listing verifiers;
code for establishing an electronic address for each of the end user business entities;
in parallel for each of the end user business entities, code for electronically submitting at least some of the respective business profile information to a business profile for the respective end user business entity at each of the associated online directory listing verifiers, including for electronically submitting to respective ones of the associated online directory listing verifiers selected portions of the respective collected business profile information that are optimized with respect to said respectively associated online directory listing verifier; and
for each of the end user business entities, code for outputting a report listing for each associated online directory listing verifier whether the business profile has been verified or actions that are needed to complete verification.

12. The non-transitory computer readable memory according to claim 11, in which the computer program further comprises code for determining whether a previously created business profile exists on the one or more online directory listing verifiers for each of the end user business entities

13. The non-transitory computer readable memory according to claim 12, wherein the previously created business profile for a given end user business entity is updated based at least on the collected business profile information.

14. The non-transitory computer readable memory according to claim 11, wherein for at least one of the end user business entities the outputted report includes at least one action that is needed to complete verification, the computer program further comprising:
code for scheduling an appointment for the at least one end user business entity to complete the at least one action needed to complete verification.

15. The non-transitory computer readable memory according to claim 11, the computer program further comprising:
code for automatically filling out forms of the business profile for the respective end user business entity at each of the associated online directory listing verifiers

16. The non-transitory computer readable memory according to claim 11, wherein the actions that are needed to complete verification include at least one of:
receiving a telephone call from one of the online directory listing verifiers;
inputting a personal identification number (PIN) from a postcard received by the respective end user business entity; and
responding to an e-mail sent to an e-mail address of the respective end user business entity.

17. The non-transitory computer readable memory according to claim 11, wherein the report further comprises a username and a password for each of the associated online directory listing verifiers.

18. The non-transitory computer readable memory according to claim 11, the computer software further comprising:
after outputting the report, code for periodically sending a request to or on behalf of at least some of the plurality of business entities to collect updated business profile information.

19. The non-transitory computer readable memory according to claim 18, further comprising:
code for periodically checking the verified profiles for a respective end user business entity to determine whether the information for a given verified profile is currently optimized for the respective online business listing verifier.

20. An apparatus comprising at least one processor and at least one memory storing a computer program, in which the at least one memory with the computer program is configured with the at least on processor to cause the apparatus to at least:
collect business profile information from each of a plurality of end user business entities, at least some of the end user business entities being independent of any other of the plurality;
associate each of the end user business entities with one or more online directory listing verifiers;
establish an electronic address for each of the end user business entities;
in parallel for each of the end user business entities, electronically submit at least some of the respective business profile information to a business profile for the respective end user business entity at each of the associated online directory listing verifiers, including for electronically submitting to respective ones of the associated online directory listing verifiers selected portions of the respective collected business profile information that are optimized with respect to said respectively associated online directory listing verifier; and
for each of the end user business entities, output a report listing for each associated online directory listing verifier whether the business profile has been verified or actions that are needed to complete verification.
